(19) United States
(12) Patent Application Publication
(10) Pub. No.: US 2005/0114140 A1
(43) Pub. Date: May 26, 2005

(54) Method and apparatus for contextual voice cues

(76) Inventors: Charles Cameron Brackett, Overland Park, KS (US); Steven Lawrence Fors, Chicago, IL (US); Denny Wingchung Lau, Sunnyvale, CA (US); Mark M. Morita, Arlington Heights, IL (US)

Correspondence Address: Patrick S. Yoder;FLETCHER YODER, P. O. Box 692289, Houston, TX, 77269-2289, US

(21) Appl. No.: 10/723,893

(22) Filed: Nov. 26, 2003

(51) Int. Cl. G10L 21/00

(52) U.S. Cl. 704/270

(57) ABSTRACT

The present invention provides a novel technique designed to provide a front-end graphical user interface for voice interaction, displaying a list of voice commands that can be used within a control scope of a medical system and that change depending on where the user is in the system. The user is presented with a quick reference guide to available commands without being overwhelmed. “Contextual voice cues” (CVC) provide a non-intrusive dynamic list of available commands to the user which automatically pop-up and change depending on the screen or mode the user is in. An indicator, such as a feedback light, may show whether a voice command is accepted. The technique may be utilized with medical information and diagnostic systems such as picture archival communication systems (PACS), ultrasound modalities, and so forth. Implementation of the technique should increase clinician adoption rates of voice recognition control and thus advance improvements in clinician workflow.

### BACKGROUND OF THE INVENTION

The present invention relates generally to medical systems, such as systems used for medical information and image handling, medical diagnostic purposes, and other purposes. More particularly, the invention relates to a technique for graphically displaying available voice commands in the voice recognition control of such medical systems.

Voice recognition, which may be implemented, for example, with speech recognition software, similar software engines, and the like, has been incorporated in a variety of applications in the medical field. Such applications may include translating dictated audio into text, identifying medical terms in voice recordings, and so forth. Currently, voice recognition is increasingly being used to drive and control medical information and diagnostic systems. This increased use of voice recognition to control medical systems is due, in part, to the potential to improve clinician workflow. Systems that may benefit from voice recognition control (voice control) include, for example, picture archival communication systems (PACS), hospital information systems (HIS), radiology department information systems (RIS), and the like. Other systems that may benefit include clinical resources of various types of modalities and analyses, such as imaging systems, electrical parameter detection devices, laboratory analyses, data input by clinicians, and so forth.

The increased use of voice control of medical systems is partly a result of the fact that control techniques employing voice recognition typically offer the clinician an ergonomic advantage over traditional non-voice graphical and textual control techniques. For example, control interfaces that make use of voice recognition may enable the user to navigate hands-free throughout the instruction and control of the medical system. This is especially beneficial, for example, for modality devices and situations where the hands are not always free, such as with ultrasound systems where the sonographer may be in the process of moving the probe around the patient and desires to change views without moving the probe from its position. In the example of information systems, such as PACS and other image handling systems, voice control offers the capability of the clinician to juggle more tasks, such as image review, reporting workflow enhancements, and so forth.

In general, voice control may improve control and clinical workflow in a variety of medical systems and situations, offering the potential to improve the speed and ease of control, as well as, advance other facets of control. A problem, however, faced by designers, manufacturers, and users of medical systems that employ voice control is the barrier of relatively low accuracy rates in voice recognition. Accuracy rates are a measure of the ability of the interface, such as a workstation or computer, to properly recognize the word or command uttered by the clinician. With undesirable accuracy rates, voice control systems often do not recognize words spoken by the clinician. In response, and to improve quality, some designers and vendors define a dictionary of words and then tune recognition and system response to those words. This is sometimes referred to as “command and control.” While this may produce better results than simple free verse, additional burden is placed upon the user to remember the words the interface recognizes. The command words are often counter-intuitive and difficult to memorize, and thus impede training and use of voice recognition systems, particularly those systems that utilize “command and control” schemes.

Vendors, in an effort to mitigate this burden, may provide the clinician with a complete list of command words the voice control system recognizes. The length of the list, however, is often prohibitive, especially for more complicated systems. In general, cheat sheets or inventories of command words frequently are cumbersome and fail to effectively inform the clinician. For example, lists delivered or communicated to the clinician as a hardcopy directory or as a listing embedded in an electronic help function, are often not user-friendly and present a distraction to the clinician. Furthermore, it may not be readily apparent to the clinician which words on a list elicit a response at any given point in the control scheme or control menu tree. As a result, clinicians may avoid use of the voice recognition control component of medical systems. In other words, confusion of the acceptable commands at given points in the control menu may discourage clinicians from taking advantage of voice control. Ultimately, clinician adoption rates of voice control are impeded and opportunities to improve clinical workflow are missed. Clinicians that may benefit from effective voice recognition control of medical systems include physicians, radiologists, surgeons, nurses, various specialists, clerical staff, insurance companies, teachers and students, and the like.

There is a need for techniques that employ voice recognition control schemes that advance accuracy rate, such as through use of “command and control” engines, but where the techniques do not require the user to remember what commands he or she can say at different points or levels in the control menu tree and that do not result in reduced clinician adoption rates. For example, there is a need for interfaces that successfully inform clinicians of the established set of control words or commands at a current point in a menu tree of a “command and control” scheme. In other words, there is a need to provide users of voice recognition control with an effective, non-intrusive, manageable set of available voice commands he or she can use while operating the medical system at the current point or scope of the menu tree. There is a need at present for more reliable and user-friendly voice recognition control of medical information and diagnostic systems which require less user training, increase clinician utilization of voice recognition to optimize clinician workflow, and permit more complicated uses of voice control.

### BRIEF DESCRIPTION OF THE INVENTION

The present invention provides a novel technique that provides a front-end graphical user interface for voice interaction and for displaying a list of voice commands that can be used within a control scope currently active in a medical system. The displayed list of voice commands may be a subset of commands and may change depending on where the user is in the system. The user is presented with a quick reference guide to available commands without being overwhelmed. In one embodiment, “contextual voice cues” (CVC) provide a non-intrusive dynamic list of available commands to the user which automatically pop-up and change depending on the screen or mode the user is in. An indicator, such as a feedback light, may show whether a voice command is accepted. In general, indicia, such as text, arrows, lights, color change, highlight, other indicators, or alterations of the display, may be used to acknowledge receipt of a voice command. The technique may be utilized with medical information and diagnostic systems that intuitively take advantage of voice recognition, such as picture archival communication systems (PACS), ultrasound modalities, and so forth. Other medical systems, however, that may less-intuitively employ voice recognition may also utilize the technique. Implementation of the technique should increase clinician adoption rates of voice recognition control and thus advance improvements in clinician workflow.

With one aspect of the invention, a method for controlling medical systems includes determining available voice commands within a medical system control scheme, graphically displaying the available voice commands, receiving one or more voice commands corresponding to one or more of the available voice commands, and implementing the one or more voice commands to control the medical system. The available voice commands may be recognizable by a voice recognition control system at a current point in a menu tree and may be graphically displayed at an interface of the medical system. The voice recognition control system may be configured for “command and control” and the available voice commands may be automatically displayed. Receipt of the one or more voice commands may be indicated, for example, producing a sound, activating a light, graphically displaying a color, graphically highlighting a displayed command, and so forth. As the user progresses in control of the medical system, the method may further include determining and graphically displaying further available commands at the interface of the medical system. Applicable medical systems may include, for example, a picture archival communication systems (PACS), hospital information systems (HIS), radiology department information systems (RIS), a magnetic resonance imaging (MRI) system, a computed tomography (CT) imaging system, an ultrasound imaging system, and so forth.

Another aspect of the invention provides a method for controlling medical systems with voice recognition control, including determining recognizable voice commands that control a medical system, displaying the recognizable voice commands at an interface of the medical system, receiving one or more voice commands corresponding to the recognizable voice commands, and executing the one or more voice commands to control the medical system. The recognizable commands may be displayed in a popup box of contextual voice cues. Additionally, the recognizable voice commands may be recognizable at a given point in a menu tree of a voice control system of the medical system. The recognizable voice commands may be a subset of the total configured voice commands of the voice control system of the medical system. Moreover, the voice recognition control system may incorporate “command and control.” The method may include indicating receipt of the one or more voice commands at the interface of the medical system, and wherein the user may acknowledge indication of the voice commands to execute the voice commands to control the medical system. Again, applicable medical systems include a picture archival communication systems (PACS), hospital information systems (HIS), radiology department information systems (RIS), a magnetic resonance imaging (MRI) system, a computed tomography (CT) imaging system, an ultrasound imaging system, and the like.

In accordance with aspects of the invention, a method for using a voice recognition control system to control a medical system may include navigating through a menu tree of a voice recognition control system of a medical system, reviewing available voice commands that are graphically displayed, speaking one or more voice commands that correspond to one or more of the available voice commands. The available voice commands may be recognizable at a current point in the menu tree, may be a subset of the total configured commands in a “command and control” voice recognition control scheme, and may be automatically displayed in a popup box of contextual voice cues. The user may verify receipt of the one or more voice commands by the voice recognition control system that controls the medical system. The user may acknowledge system receipt of a delivered voice command to initiate execution of the voice command. The user may further navigate through the menu tree of the medical system. Such medical systems may include, for example, a medical information system, a medical diagnostic system, and a medical information and diagnostic system.

Aspects of the invention provide for a system to control a medical system including a control system configured to recognize and implement received voice commands to control a medical system, a control interface that graphically displays available voice commands that are recognizable at a particular point in a control scheme of the control system, and wherein the control interface is configured to indicate recognition and receipt of a user voice command that corresponds to the available voice commands. The particular point may be a present point in the control scheme and the available voice commands may be automatically displayed. Additionally, the control scheme may be a “command and control” scheme. Again, the medical system may be a medical information system, a medical diagnostic system, a medical information and diagnostic system, and the like. In particular, the medical system may be a PACS, the control interface may be a PACS workstation, and the available voice commands may be displayed on the PACS workstation monitor.

Other aspects of the invention provide for a system for controlling a medical system, including a control system configured to recognize and execute voice commands uttered by a user to control a medical system, and a graphical user interface that displays recognizable voice commands that correspond to a real time position within a menu tree of the control system. The graphical user interface may be configured to indicate control system receipt of a voice command uttered by the user and recognized by the control system. The control system may be configured to execute received voice commands upon acknowledgement by the user.

Facets of the invention provide for a control system for controlling a medical system, including means for recognizing and applying voice commands uttered by a user to control a medical system, means for graphically displaying acceptable voice commands at an interface of the medical system, and means for indicating recognition and receipt of one or more voice commands uttered by the user which correspond to one or more of the acceptable voice commands. Additionally, the control system may include means for employing a control scheme that incorporates “command and control” and where the acceptable voice commands are voice commands that are recognizable and available at a particular position in the control scheme. The system may include means for the user to acknowledge indication that the control system has recognized and received the uttered voice command before the control system applies the uttered voice command to control the medical system.

In accordance with aspects of the invention, a computer program, provided on one or more tangible media, for controlling a medical system, may include a routine for determining available voice commands within a medical system control scheme, a routine for graphically displaying the available voice commands at an interface of the medical system, a routine for receiving one or more voice commands corresponding to one or more of the available voice commands, and a routine for implementing the one or more voice commands to control the medical system. In accordance with yet other aspects of the invention, another computer program, provided on one or more tangible media, for controlling a medical system, may include a routine for recognizing and applying voice commands uttered by a user to control a medical system, a routine for graphically displaying acceptable voice commands at an interface of the medical system, and a routine for indicating recognition and receipt of one or more voice commands uttered by the user which correspond to one or more of the acceptable voice commands.

### BRIEF DESCRIPTION OF THE DRAWINGS

FIG. 1 is a diagrammatical overview of medical information and diagnostic systems networked within a medical institution that may employ voice recognition control in accordance with aspects of the present technique;

FIG. 2 is a diagrammatical representation of an exemplary image management system, in the illustrated example a picture archiving and communication system or PACS, for receiving, storing, and displaying image data in accordance with certain aspects of the present technique;

FIG. 3 is a diagrammatical representation of an exemplary PACS workstation display showing an ultrasound image and a popup box with contextual voice cues;

FIG. 4 is a diagrammatical representation of the popup box of contextual voice cues of FIG. 3 showing available commands and a description of those commands;

FIG. 5 is a block diagram of an overview of a control scheme for voice recognition control in accordance with aspects of the present technique; and

FIG. 6 is a block diagram of an overview of a user method for the voice recognition control scheme of FIG. 4 and other voice recognition control schemes employing “command and control” in accordance with aspects of the present technique.

### DETAILED DESCRIPTION OF SPECIFIC EMBODIMENTS

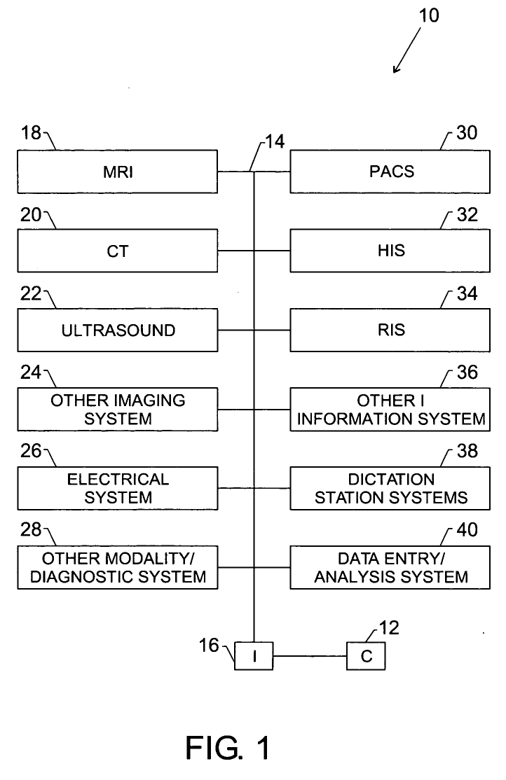

Turning now to the drawings and referring initially to FIG. 1, a diagrammatical overview of medical information and diagnostic systems networked within a medical institution 10 that may employ voice recognition control in accordance with the present technique is depicted. In this example, a client 12, such as a clinician, physician, radiologist, nurse, clerk, teacher, student, and the like, may access, locally or remotely, medical information and diagnostic systems and data repositories connected to a medical facility network 14. The client 12 may access such a network 14 via an interface 16, such as a workstation or computer. A medical facility network 14 typically includes additional interfaces and translators between the systems and repositories, as well as, processing capabilities including analysis, reporting, display and other functions. The interfaces, repositories, and processing resources may be expandable and may be physically resident at any number of locations, typically linked by dedicated or open network links. The network links may typically include computer interconnections, network connections, local area networks, virtual private networks, and so forth. It should be noted that instead of as illustrated, the systems represented in FIG. 1 which may utilize aspects of the present technique may exist independent as a stand alone system and not networked to other medical systems.

The medical information and diagnostic systems depicted in FIG. 1 may each typically be associated with at least one operator interface that may be configured to employ voice recognition control, and in particular, to utilize a “command and control” scheme. The medical systems depicted in FIG. 1, for example, may have an operator interface disposed within the medical system that provides an input station or workstation for control, a monitor for displaying data and images, and so forth. An operator interface may also exist at a junction between a medical system and the network 14, as well as, between a medical system and other internal or external data connections. Medical systems that may apply voice control with aspects of the present technique include, for example, one or more imaging systems, such as a magnetic resonance imaging (MRI) system 18, a computed tomography (CT) imaging system 20, and an ultrasound system 22. Other imaging acquisition systems 24 that may make use of voice control include, for example, x-ray imaging systems, positron emission tomography (PET) systems, mammography systems, sonography systems, infrared imaging systems, nuclear imaging systems, and the like.

Imaging resources are typically available for diagnosing medical events and conditions in both soft and hard tissue, for analyzing structures and function of specific anatomies, and in general, for screening internal body parts and tissue. The components of an imaging system generally include some type of imager which detects signals and converts the signals to useful data. In general, image data indicative of regions of interest in a patient are created by the imager either in a conventional support, such as photographic film, or in a digital medium. In the case of analog media, such as photographic film, the hard copies produced may be subsequently digitized. Ultimately, image data may be forwarded to some type of operator interface in the medical facility network 14 for viewing, storing, and analysis. Image acquisition, processing, storing, viewing, and the like, may be controlled via voice recognition combined with embodiments of the present technique, such as incorporation of contextual voice cues.

In the specific example of an MRI 18, a front-end graphical user interface for voice interaction in line with the present technique may improve the MRI system 18 clinical workflow and thus reduce the time required in both the acquisition of image data and in the subsequent processing and review of the image data. The MRI imaging system 18 typically includes a scanner having a primary magnet for generating a magnetic field. A patient is positioned against the scanner and the magnetic field influences gyromagnetic materials within the patient's body. As the gyromagnetic materials, typically water and metabolites, attempt to align with the magnetic field, other magnets or coils produce additional magnetic fields at differing orientations to effectively select a slice of tissue through the patient for imaging. Data processing circuitry receives the detected MR signals and processes the signals to obtain data for reconstruction. The resulting processed image data is typically forwarded locally or via a network, to an operator interface for viewing, as well as to short or long-term storage. Implementation of the present technique may reduce MRI testing time and thus improve patient comfort, which may be especially important, for example, for claustrophobic patients subjected to MRI testing. It should be apparent, however, that with any medical information and diagnostic system, voice control should not be intended to override manual safety steps, switches, interlocks, and the like, unless deemed acceptable to do so by the appropriate institution, personnel, regulatory body, and so forth.

For the example of CT, the basic components of a CT imaging system 20 include a radiation source and detector. During an examination sequence, as the source and detector are rotated, a series of view frames are generated at angularly-displaced locations around a patient positioned within a gantry. A number of view frames (e.g. between 500 and 1000) may be collected for each rotation. For each view frame, data is collected from individual pixel locations of the detector to generate a large volume of discrete data. Data collected by the detector is digitized and forwarded to data acquisition and processing circuitries, which process the data and generate a data file accessible, for example on a medical facility network 14. It should be apparent that voice control combined with aspects of the present technique would improve clinician workflow in the complex undertaking of image acquisition with a CT system. As might be expected, it is generally important for the clinician to specify and/or monitor the appropriate angles and numbers of frames, the position of the patient, the handling of the large volume of data, and so forth. To facilitate workflow, for example, in the voice control scheme of a CT system 20, a graphical “popup box” displayed on a CT control interface monitor may provide a subset of recognized voice commands. In one embodiment, the recognizable voice commands presented in the popup box automatically change depending on the user's position in the menu tree and thus, in the context of operation of a CT and other medical systems, the clinician may focus more on workflow instead of struggling to remember recognizable voice commands.

As previously mentioned, an ultrasound imaging system 22 may benefit from voice recognition control and aspects of the present technique. Sonography and ultrasonography techniques, such as with an ultrasound imaging system 22, generally employ high-frequency sound waves rather than ionizing or other types of radiation. The systems include a probe which is placed immediately adjacent to a patient's skin on which a gel may be disposed to facilitate transmission of the sound waves and reception of reflections. Reflections of the sound beam from tissue planes and structures with differing acoustic properties are detected and processed. Brightness levels in the resulting data are indicative of the intensity of the reflected sound waves. Ultrasound (or ultrasonography) is generally performed in real-time with a continuous display of the image on a video monitor. Freeze-frame images may be captured, such as to document views displayed during the real-time study. Ultrasonography presents certain advantages over other imaging techniques, such as the absence of ionizing radiation, the high degree of portability of the systems, and their relatively low cost. In particular, ultrasound examinations can be performed at a bedside or in an emergency department by use of a mobile system. As with other imaging systems, results of ultrasonography may be viewed immediately, or may be stored for later viewing, transmission to remote locations, and analysis. The ultrasound modality may be especially benefited by control interfaces that make use of voice recognition and thus enable the clinician to navigate hands-free. For example, as previously mentioned, in ultrasound testing, situations arise where the hands are not always free, such as with when the sonographer is in the process of moving the probe around the patient and desires to change views without moving the probe from its position. Another example is a mobile or emergency environment where even more demanding multi-tasking is common.

Electrical systems 26 that may take advantage of the present technique include electrical data resources and modalities, such as electroencephalography (EEG), electrocardiography (ECG or EKG), electromyography (EMG), electrical impedance tomography (EIT), nerve conduction test, electronystagmography resources (ENG), combinations of such modalities, and other electrical modalities. Electrical system components typically include sensors, transducers, monitors, and the like, which may be placed on or about a patient to detect certain parameters of interest indicative of medical events or conditions. Thus, the sensors may detect electrical signals emanating from the body or portions of the body, pressure created by certain types of movement (e.g. pulse, respiration), or parameters such as movement, reactions to stimuli, and so forth. The sensors may be placed on external regions of the body, but may also include placement within the body, such as through catheters, injected or ingested means, and other means. Aspects of the present technique may permit the clinician to navigate through a control of the electrical system hands-free, and thus better concentrate on clinical vigilance, particularly concentrating, for example, on patient comfort, correct placement of sensors, data collection, and the like.

Other modality/diagnostic systems 28 that may benefit from the present technique include a variety of systems designed to detect physiological parameters of patients. Such systems 28 may include clinical laboratory resources (i.e., blood or urine tests), histological data resources (i.e., tissue analysis or crytology), blood pressure analyses, and so forth. In the laboratory, for example, the operation of analytical devices, instruments, machines, and the like, may benefit from incorporation of the present technique. Additionally, benefits from voice control may be realized in the handling and review of resulting output data, which may be stored, for example, on a system computer or at other repositories or storage sites linked to the medical facility network 14.

Information systems within a hospital or institution which may incorporate aspects of the present technique include, for example, picture and archival communication systems (PACS) 30, hospital information systems (HIS) 32, radiological information systems (RIS) 34, and other information systems 36, such as cardiovascular information systems (CVIS), and the like. Embodiments of the present technique may be especially helpful with a PACS 30, which is an excellent candidate for voice recognition control, in part, because of the multi-tasking nature and use of the operation and interface of a PACS 30. Image handling systems, such as a PACS 30, have increasingly become one of the focal points in a medical institution and typically permit a clinician to display a combination of patient information and multiple images in various views, for example, on one or more PACS 30 monitors. A PACS 30 typically consists of image and data acquisition, storage, and display subsystems integrated by various digital networks. A PACS 30 may be as simple as a film digitizer connected to a display workstation with a small image data base, or as complex as a total hospital image management system At either extreme, a “command and control” voice recognition control scheme that graphically displays a non-intrusive dynamic list of recognizable voice commands may assist in the processing and review of patient data and images. Such processing and review may be conducted, for example, by an operator or clinician at a PACS 30 interface (e.g., workstation). Clinicians commonly review and page through image studies at a PACS 30 workstation. In sum, this type of review of image studies may be facilitated by a voice recognition control scheme that displays a subset of recognizable voice commands that automatically change depending on the current screen or mode

The size and versatility of many of the image handling systems in the medical field should be emphasized. For example, a PACS 30 often functions as a central repository of image data, receiving the data from various sources, such as medical imaging systems. The image data is stored and made available to radiologists, diagnosing and referring physicians, and other specialists via network links. Improvements in PACS have led to dramatic advances in the volumes of image data available, and have facilitated loading and transferring of voluminous data files both within institutions and between the central storage location or locations and remote clients. A major challenge, however, to further improvements in all image handling systems, from simple Internet browsers to PACS in medical diagnostic applications, is advancing clinician workflow. As technology advances, clinicians may be required to perform a wide variety of tasks, some complicated. These concerns apply both to the up-front acquisition of medical images, as well as, to the downstream processing and review of medical images, such as the review conducted at a PACS workstation.

In the medical diagnostics field, depending upon the imaging modalities previously discussed, the clinician may acquire and process a substantial number of images in a single examination. Computed tomography (CT) imaging systems, for example, can produce numerous separate images along an anatomy of interest in a very short examination timeframe. Ideally, all such images are stored centrally on the PACS, and made available to the radiologist for review and diagnosis. As will be appreciated by those skilled in the art, a control system that frees a clinician's hands, such as through voice control, may advance clinical vigilance by improving clinician workflow both in the acquisition of images and in the further processing and storing of the images. For image review and processing at a PACS interface or workstation, the present technique by providing, for example, voice control with both user-friendly abridged and/or unabridged directories of commands or available commands, may increase the capability of the clinician to review a greater number of images in less time. This may result, for example, in improved diagnosis time.

Similarly, other institutional systems having operator interfaces that may incorporate the present technique, including, for example, a hospital information system (HIS) 32 and radiological information system (RIS) 34. The HIS 32 is generally a computerized management system for handling tasks in a health care environment, such as support of clinical and medical patient care activities in the hospital, administration of the hospital's daily business transactions, and evaluation and forecasting of hospital performance and costs. The HIS 32 may provide for automation of events such as patient registration, admissions, discharged, transfers, and accounting. It may also provide access to patient clinical results (e.g., laboratory, pathology, microbiology, pharmacy, radiology). It should be noted that radiology, pathology, pharmacy, clinical laboratories, and other clinical departments in a health care center typically have their own specific operational requirements, which differ from those of general hospital operation. For this reason, special information systems, such as the RIS 34, are typically needed. Often, these subsystems are under the umbrella of the HIS 32. Others may have their own separate information systems with interface mechanisms for transfer of data between these subsystems and the HIS 32. A software package, such as Summary True Oriented Results reporting (STOR) may provide a path for the HIS 32 to distribute HL7®-formated data to other systems and the outside world. For example, the HIS 32 may broadcast in real time the patient demographics and encounter information with HL7® standards to other systems, such as to the RIS 34 and the PACS 30. A radiology department information system (RIS) 34 is generally designed to support both administrative and clinical operations of a radiology department by managing, for example, radiology patient demographics and scheduling. The RIS 34 typically includes scanners, control systems, or departmental management systems or servers. The RIS 34 configuration may be very similar to the HIS 32, except the RIS 34 is typically on a smaller scale. In most cases, an independent RIS 34 is autonomous with limited access to the HIS 32. However, some HIS 32 systems offer embedded RIS 34 subsystems with a higher degree of integration.

In the control of medical information systems like the HIS 32 and RIS 34, as well as, in the control of other medical systems, such as image handling systems, modality systems, and so forth, it may be important for the user to verify that the control system recognized, acknowledged, and received the intended voice command. Additionally, it may be appropriate for the user to also acknowledge that the system received the intended command, for example, to permit the system to execute the command. Aspects of the present technique address such concerns, for example, by providing for the control scheme or system to acknowledge or indicate receipt of a voice command. Indicia, such as text, arrows, lights, color change, highlight, other indicators, or alterations of the display, may be used to indicate or acknowledge receipt of a voice command.

An increasingly prevalent area in the medical field that may benefit from application of the technique is dictation. A traditional application of dictation has been the dictation of radiological reports, which may be transcribed into a textual form and inserted, for example, into a RIS 32. The transcription is typically manual because voice recognition transcription has yet to gain widespread acceptance due to the accuracy problems of voice recognition previously discussed. However, the control of a dictation station 38 may be conducive to a voice recognition scheme having, for example, a “command and control” setup.

Audio data is typically recorded by a clinician or radiologist through an audio input device, such as a microphone. A radiological report, for example, is dictated by the clinician or radiologists to compliment or annotate the radiological images generated by the one or more of the imaging systems previously mentioned. As will be appreciated by those skilled in the art, the radiologist in dictating a report may typically physically handle multiple images while at the same time manipulate control of the dictation station 38. A reliable voice control component incorporating portions of the present technique may permit the clinician, such as a radiologist, to record audio “hands-free” and allow clinician, for example, while dictating to focus more on examination of images and review of other pertinent patient information. Additionally, the time required for dictation may be reduced and the clinician workflow improved. In general, a variety of data entry/analysis systems 40 may benefit, for example, from voice recognition control systems that display a quick reference guide of currently available commands.

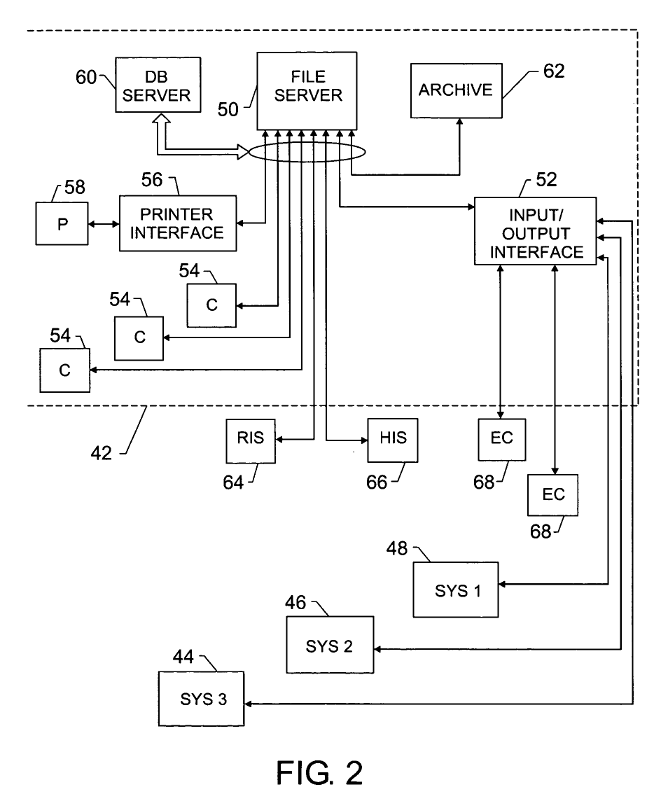

FIG. 2 illustrates an exemplary image data management system in the form of a PACS 30 for receiving, processing, and storing image data. In the illustrated embodiment, PACS 30 receives image data from several separate imaging systems designated by reference numerals 44, 46 and 48. As will be appreciated by those skilled in the art, the imaging systems may be of the various types and modalities previously discussed, such as magnetic resonance imaging (MRI) systems, computed tomography (CT) systems, positron emission tomography (PET) systems, radio fluoroscopy (RF), computed radiography (CR), ultrasound systems, and so forth. Moreover, as previously noted, the systems may include processing stations or digitizing stations, such as equipment designed to provide digitized image data based upon existing film or hard copy images. It should also be noted that the systems supplying the image data to the PACS 30 may be located locally with respect to the PACS 30, such as in the same institution or facility, or may be entirely remote from the PACS 30, such as in an outlying clinic or affiliated institution. In the latter case, the image data may be transmitted via any suitable network link, including open networks, proprietary networks, virtual private networks, and so forth. The multi-tasking and multi-event nature of a PACS 30 is reviewed in more detail to discuss application of the present technique.

PACS 30 includes one or more file servers 50 designed to receive, process, and/or store image data, and to make the image data available for further processing and review. Server 50 receives the image data through an input/output interface 52, which may, for example, serve to compress the incoming image data, while maintaining descriptive image data available for reference by server 50 and other components of the PACS 30. Where desired, server 50 and/or interface 52 may also serve to process image data accessed through the server 50. The server is also coupled to internal clients, as indicated at reference numeral 54, each client typically including a workstation at which a radiologist, physician, or clinician may access image data from the server and view or output the image data as desired. Such a reviewing workstation is discussed more below, and as discussed earlier, is an example of where aspects of the present technique may be implemented. Clients 54 may also input information, such as dictation of a radiologist following review of examination sequences. Similarly, server 50 may be coupled to one or more interfaces, such as a printer interface 56 designed to access image data and to output hard copy images via a printer 58 or other peripheral.

Server 50 may associate image data, and other workflow information within the PACS 30 by reference to one or more database servers 60, which may include cross-referenced information regarding specific image sequences, referring or diagnosing physician information, patient information, background information, work list cross-references, and so forth. The information within database server 60, such as a DICOM database server, serves to facilitate storage and association of the image data files with one another, and to allow requesting clients to rapidly and accurately access image data files stored within the system.

Similarly, server 50 may be coupled to one or more archives 62, such as an optical storage system, which serve as repositories of large volumes of image data for backup and archiving purposes. Techniques for transferring image data between server 50, and any memory associated with server 50 forming a short term storage system, and archive 62, may follow any suitable data management scheme, such as to archive image data following review and dictation by a radiologist, or after a sufficient time has lapsed since the receipt or review of the image files. An archive 62 system may be designed to receive and process image data, and to make the image data available for review.

Additional systems may be linked to the PACS 30, such as directly to server 50, or through interfaces such as interface 52. A radiology department information system or RIS 64 may be linked to server 50 to facilitate exchanges of data, typically cross-referencing data within database server 60, and a central or departmental information system or database. Similarly, a hospital information system or HIS 66 may be coupled to server 50 to similarly exchange database information, workflow information, and so forth. Where desired, such systems may be interfaced through data exchange software, or may be partially or fully integrated with the PACS 30 to provide access to data between the PACS 30 database and radiology department or hospital databases, or to provide a single cross-referencing database. Similarly, external clients, as designated at reference numeral 68, may be interfaced with the PACS 30 to enable images to be viewed at remote locations. Again, links to such external clients may be made through any suitable connection, such as wide area networks, virtual private networks, and so forth. Such external clients may employ a variety of interfaces, such as computers or workstations, to process and review image data retrieved from the PACS 30.

Similarly, as previously indicated, the one or more clients 54 may comprise a diagnostic workstation to enable a user to access and manipulate images from one or more of the imaging systems either directly (not shown) or via the file server 50. These reviewing workstations (e.g., at client 54) at which a radiologist, physician, or clinician may access and view image data from the server 50 typically include a computer monitor, a keyboard, as well as other input devices, such as a mouse. The reviewing workstation enables the client to view and manipulate data from a plurality of imaging systems, such as MRI systems, CT systems, PET systems, RF, and ultrasound systems.

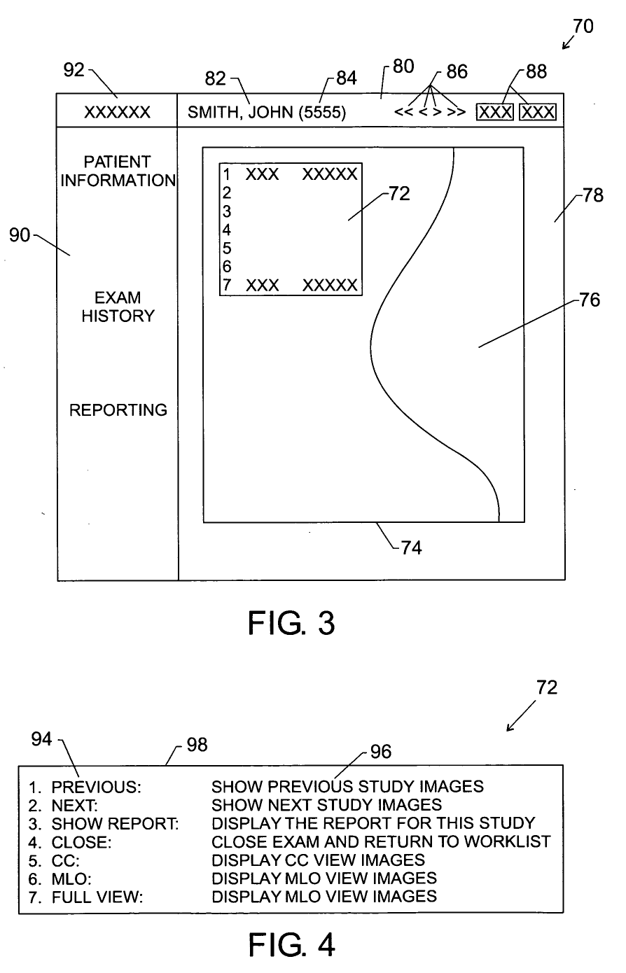

Referring to FIG. 3, a diagrammatical representation of an exemplary PACS workstation display 70 showing a popup box 72 with contextual voice cues on a mammography image 76, is depicted. The illustration is typical of a portion of a PACS workstation display of mammography exam results. Additional mammography images acquired during the mammography exam may be displayed adjacent to image 76 on the same PACS monitor (display 70) or different monitors.

During the mammography exam, mammography imaging commonly uses low-dose X-ray systems and high-contrast, high-resolution film, or digital X-ray systems, for examination of the breasts. Other mammography systems may employ CT imaging systems of the type described above, collecting sets of information which are used to reconstruct useful images. A typical mammography unit includes a source of X-ray radiation, such as a conventional X-ray tube, which may be adapted for various emission levels and filtration of radiation. An X-ray film or digital detector is placed in an oppose location from the radiation source, and the breast is compressed by plates disposed between these components to enhance the coverage and to aid in localizing features or abnormalities detectable in the reconstructed images.

In sum, it is typical to analyze and review current and/or historical mammography images, as well as other modality images, on a PACS 30 workstation. As mentioned before, a PACS 30 generally consists of image/data acquisition, controller or server functions, archival functions, and display subsystems, which may be integrated by digital networks. Images and related patient data may be sent from imaging modalities or devices, such as a mammography imaging system, to the PACS 30. For example, in a peer-to-peer network, an imaging modality computer may “push” to a PACS 30 acquisition computer or interface, or the PACS 30 acquisition computer may “pull.” The acquisition computer, along with other information handling applications, such as the HIS 32, the RIS 34, may push imaging examinations, such as mammography examination images, along with pertinent patient information to a PACS 30 controller or server. For storage, the archival functions may consist of short-term, long-term, and permanent storage.

In one embodiment of the present technique, a popup box 72 and mammography image 76 of a breast 76 are displayed on an exemplary PACS workstation display 70. The popup box 72 of the contextual voice cues, may be brought into view, for example, by keyboard action, voice command, or automatically. Also shown are a display background 78 and a menu bar 80. Examples of items on a menu bar 80 are the patient name 82, patient identification number 84, and arrows 86 that may be used, for example, for paging back and forth. Additionally, the menu bar 80 may include one or more buttons 88 with descriptive text, which may be user selectable and implement commands. The display 70 may also have an information bar 90 that provides, for example, patient information, exam history, reporting information, and the like. The information bar 90 may have additional items, such as text 92, which may, for example, identify the particular PACS 30. It should be emphasized that FIG. 3 is only given as an illustrative example of a PACS workstation display 70, and that different information and/or different graphical user interfaces may be included in a PACS workstation display 70 and other displays in accordance with the present technique.

FIG. 4 is a diagrammatical representation of the popup box 72 of contextual voice cues of FIG. 3 showing available voice commands 94 and a description 96 of those commands. The popup box 44 is defined and enclosed by a border 98. In this illustrative embodiment, seven voice commands are available at this point in the menu tree. The exemplary commands manipulate the view, as well as retrieve and display different types of images. Moreover, upon a user speaking one of the seven available voice commands, the voice control system may indicate the selection, such as by highlighting the selected command. In one example, the speaker may utter “previous” to page back to a previous view of an image or study, or to retrieve a previously-acquired image, and so forth. The system may indicate receipt of the command, for example, by highlighting the text “previous” or the description “show previous study images” or both.

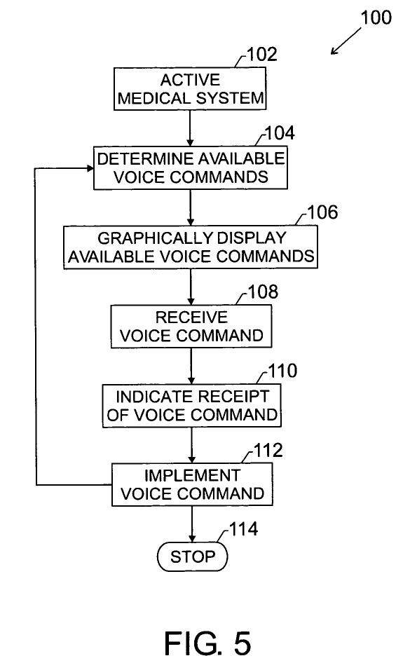

FIG. 5 is a block diagram of an overview of a control scheme 100 for voice recognition control that uses “command and control.” Initially, the applicable medical system is active, as indicated by block 102, which may be representative of a clinician, for example, turning on the medical information and/or diagnostic system, or having navigated to some later point in the control system menu tree. Later points in the menu tree may be reached, for example, by keyboard command or voice command. With the voice control scheme 100 active within the active medical system, the voice control scheme 100 determines available voice commands (block 104). In this embodiment, the subset of voice commands that are available are graphically displayed (block 106). This display of voice commands may be automatic, or instead initiated, for example, by voice or manual entry, such as a keyboard entry. A user may then review the displayed available voice commands and speak the desired voice command corresponding to one of the available commands. Block 108 is representative of the control system receiving and recognizing voice commands uttered by the user.

Receipt of the voice command may be indicated (block 110) in a variety of ways, such with an indicator light, by highlighting the selected command, with sound indication, or by simply implementing the command, and so forth. Upon implementation of the voice command (block 112), the control scheme may again determine the available subset of voice commands which may change as the user navigates through the menu tree (block 114). The user may abandon voice control, for example, by shutting down the system, deactivating the voice control, and the like. The user may stop or idle the voice control at any point in the control scheme 100 flow, this action represented by stop block 114.

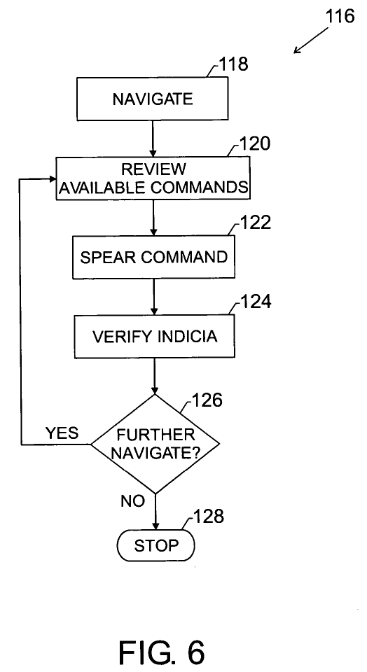

FIG. 6 is a block diagram of an overview of a user method 116 for the voice recognition control scheme of FIG. 5 and other voice recognition control schemes that may employ “command and control.” Block 118 represents the user having navigated through the system, either at initial startup or at some point later in the menu tree. The user or clinician may review available commands, for example, in a popup box 72 (block 120). It should be emphasized that a particularly powerful aspect of the present technique is the dynamic nature of the list of available commands which may change depending on where the user is operating in the system. Thus, the user may only be presented with the available commands that will be accepted at that point in the menu tree. The user may speak the desired command (block 122) and verify that the system received the command (block 124). The user may further navigate (block 126) through the system and the user method 88 illustrated in FIG. 5 is repeated, or the user may abandon use of voice control (block 128). In general, the user or clinician may acknowledge that the voice control system recognized and received the intended voice command to initiate execution of the command. In particular, after the system indicates or acknowledges receipt of the command, for example, by highlighting the command, the user may then acknowledge the highlighted command, such as by speaking “okay,” “accept,” and the like, to permit the system to implement the command. On the other hand, the control system may be configured so that a voice command may execute without the user acknowledging that the control system received the correct command.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for controlling medical systems, comprising:
determining available voice commands within a medical system control scheme;
graphically displaying the available voice commands;
receiving one or more voice commands corresponding to one or more of the available voice commands; and
implementing the one or more voice commands to control the medical system.

2. The method of claim 1, wherein the available voice commands are recognizable by a voice recognition control system at a current point in a menu tree and are graphically displayed at an interface of the medical system.

3. The method of claim 2, wherein the voice recognition control system is configured for “command and control” and the available voice commands are automatically displayed.

4. The method of claim 1, further comprising indicating receipt of the one or more voice commands.

5. The method of claim 4, wherein indicating receipt of the one or more voice commands comprises at least one of producing a sound, activating a light, graphically displaying a color, and graphically highlighting a displayed command.

6. The method of claim 1, further comprising determining and graphically displaying further available commands at the interface of the medical system.

7. The method of claim 1, wherein the medical system is at least one of a picture archival communication systems (PACS), hospital information systems (HIS), radiology department information systems (RIS), a magnetic resonance imaging (MRI) system, a computed tomography (CT) imaging system, and an ultrasound imaging system.

8. A method for controlling medical systems with voice recognition control, comprising:
determining recognizable voice commands that control a medical system;
displaying the recognizable voice commands at an interface of the medical system;
receiving one or more voice commands corresponding to the recognizable voice commands; and
executing the one or more voice commands to control the medical system.

9. The method of claim 8, wherein the recognizable commands are displayed in a popup box of contextual voice cues.

10. The method of claim 8, wherein the recognizable voice commands are recognizable at a given point in a menu tree of a voice control system of the medical system.

11. The method of claim 10, wherein the recognizable voice commands are a subset of the total configured voice commands of the voice control system of the medical system.

12. The method of claim 11, wherein the voice recognition control system incorporates “command and control.”

13. The method of claim 8, further comprising indicating receipt of the one or more voice commands at the interface of the medical system.

14. The method of claim 9, wherein the user acknowledges indication of the one or more voice commands initiates execution of the one or more voice commands to control the medical system.

15. The method of claim 8, wherein the medical system is at least one of a picture archival communication systems (PACS), hospital information systems (HIS), radiology department information systems (RIS), a magnetic resonance imaging (MRI) system, a computed tomography (CT) imaging system, and an ultrasound imaging system.

16. A method for using a voice recognition control system to control a medical system comprising:
navigating through a menu tree of a voice recognition control system of a medical system;
reviewing available voice commands that are graphically displayed;
speaking one or more voice commands that correspond to one or more of the available voice commands.

17. The method of claim 16, wherein the available voice commands comprise commands that are recognizable at a current point in the menu tree and that are a subset of the total configured commands in a “command and control” voice recognition control scheme.

18. The method of claim 16, wherein the available voice commands are automatically displayed in a popup box of contextual voice cues.

19. The method of claim 16, further comprising verifying receipt of the one or more voice commands by the voice recognition control system that controls the medical system.

20. The method of claim 19, further comprising acknowledging system receipt of a delivered voice command to initiate execution of the voice command.

21. The method of claim 16, further comprising further navigating through the menu tree.

22. The method of claim 16, wherein the medical system is at least one of a medical information system, a medical diagnostic system, and a medical information and diagnostic system.

23. A system for controlling a medical system comprising:
a control system configured to recognize and implement received voice commands to control a medical system;
a control interface that graphically displays available voice commands that are recognizable at a particular point in a control scheme of the control system; and
wherein the control interface is configured to indicate recognition and receipt of a user voice command that corresponds to the available voice commands.

24. The system of claim 23, wherein the particular point is a present point in the control scheme.

25. The system of claim 24, wherein the available voice commands are automatically displayed.

26. The system of claim 23, wherein the control scheme is a “command and control” scheme.

27. The system of claim 23, wherein the medical system is at least one of a medical information system, a medical diagnostic system, and a medical information and diagnostic system.

28. The system of claim 27, wherein the medical system is a PACS and the control interface is a PACS workstation.

29. The system of claim 28, wherein the available voice commands are displayed on a PACS workstation monitor.

30. A system for controlling a medical system comprising:
a control system configured to recognize and execute voice commands uttered by a user to control a medical system; and
a graphical user interface that displays recognizable voice commands that correspond to a real time position within a menu tree of the control system.

31. The system of claim 30, wherein the graphical user interface is configured to indicate control system receipt of a voice command uttered by the user and recognized by the control system.

32. The system of claim 31, wherein the control system is configured to execute received voice commands upon acknowledgement by the user.

33. A control system for controlling a medical system comprising:
means for recognizing and applying voice commands uttered by a user to control a medical system;
means for graphically displaying acceptable voice commands at an interface of the medical system; and
means for indicating recognition and receipt of one or more voice commands uttered by the user which correspond to one or more of the acceptable voice commands.

34. The control system of claim 33, comprising means for employing a control scheme that incorporates “command and control” and where the acceptable voice commands are voice commands that are recognizable and available at a particular position in the control scheme.

35. The system of claim 33, comprising means for the user to acknowledge indication that the control system has recognized and received the uttered voice command before the control system applies the uttered voice command to control the medical system.

36. A computer program, provided on one or more tangible media, for controlling a medical system, comprising:
a routine for determining available voice commands within a medical system control scheme;
a routine for graphically displaying the available voice commands at an interface of the medical system;
a routine for receiving one or more voice commands corresponding to one or more of the available voice commands; and
a routine for implementing the one or more voice commands to control the medical system.

37. A computer program, provided on one or more tangible media, for controlling a medical system, comprising:
a routine for recognizing and applying voice commands uttered by a user to control a medical system;
a routine for graphically displaying acceptable voice commands at an interface of the medical system; and
a routine for indicating recognition and receipt of one or more voice commands uttered by the user which correspond to one or more of the acceptable voice commands.
